(19) United States
(12) Patent Application Publication
(10) Pub. No.: US 2016/0217406 A1
(43) Pub. Date: Jul. 28, 2016

(54) Self-Learning Supply Chain System

(71) Applicant: JDA Software Group, Inc., Scottsdale, AZ (US)

(72) Inventor: Adeel Najmi, Plano, TX (US)

(21) Appl. No.: 15/093,449

(22) Filed: Apr. 7, 2016

Related U.S. Application Data
(62) Division of application No. 14/210,373, filed on Mar. 13, 2014.
(60) Provisional application No. 61/780,583, filed on Mar. 13, 2013.

(51) Int. Cl. G06Q 10/06; G06N 99/00

(52) U.S. Cl. CPC G06Q 10/06315; G06Q 10/067; G06N 99/005

(57) ABSTRACT

A system and method are disclosed for a self-learning supply chain comprising closed-loop feedback monitoring of compliance, levers effectiveness, key assumptions, early warning sensors, and key performance indicators. Self-learning supply chain enables root cause analysis of supply chain execution failures and problems and provides tools to planners to proactively resolve supply chain disruptions.

### CROSS-REFERENCE TO RELATED APPLICATIONS

This application is a division of U.S. patent application Ser. No. 14/210,373, filed on Mar. 13, 2014, entitled “Self-Learning Supply Chain System,” which claims the benefit under 35 U.S.C. §119(e) to U.S. Provisional Application No. 61/780,583, filed Mar. 13, 2013, and entitled “Self-Learning Supply Chain System.” U.S. patent application Ser. No. 14/210,373 and U.S. Provisional Application No. 61/780,583 are assigned to the assignee of the present application. The subject matter disclosed in U.S. patent application Ser. No. 14/210,373 and U.S. Provisional Application No. 61/780,583 is hereby incorporated by reference into the present disclosure as if fully set forth herein.

### TECHNICAL FIELD

The present disclosure relates generally to supply chain management and specifically to a system and method for self-learning supply chain management.

### BACKGROUND

Fickle consumers, growing market volatility, exploding product portfolios, increasing complexity of supply chains and lengthening lead times have all compounded to make supply chain management a daunting task. Supply chain management has traditionally lagged customer needs and has proven inadequate to adapt to usability, agility, alignment and learning. This inability of supply chain management software to predict and adapt to customer needs is undesirable.

### SUMMARY

A method of optimizing supply chain performance is disclosed. The method includes determining a plan comprising at least one performance goal, at least one key assumption, and at least one segment and executing the plan by managing the at least one key assumption to determine the validity of the assumption. The method also includes determining one or more risks for a supply chain disruption, utilizing at least one corrective action lever when a supply chain disruption occurs and identifying one or more root causes of a plan problem that occurs during the execution of the plan. The method further includes monitoring one or more segments with each execution of the plan, determining one or more contingency plans for each of the supply chain disruptions, tracking the plan problem and one or more resolutions of the plan problem and adjusting the plan for one or more resolution levers by the segment with each plan execution.

A system for supply chain performance optimization is disclosed. The system includes a supply chain planning database that receives supply chain data from a transaction system, and communicates the supply chain data to a planning model engine and a risks and assumptions repository that receives supply chain data from the transaction system, and communicates updated supply chain assumptions to the supply chain planning database. The system also includes a persistent problems and work order management repository that communicates supply chain problems and supply chain problems resolutions with the planning model engine, a root cause diagnostic library tangibly that communicates one or more performance deviations with the planning model engine and a planning levers library that determines at least one corrective action to resolve the one or more performance deviations.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates an exemplary supply chain system according to an embodiment;

FIG. 2 illustrates self-learning system of FIG. 1 in greater detail according to an embodiment;

FIG. 3A illustrates self-learning system of FIG. 2 in greater detail according to an embodiment;

FIG. 3B illustrates the knowledge data layer of FIG. 2 and FIG. 3A in greater detail according to an embodiment;

FIG. 4A-4B illustrate a traditional supply chain planning system according to the prior art;

FIG. 5 illustrates a closed loop control process according to an embodiment;

FIGS. 6A-6D illustrate a self-learning supply chain system with closed loop control according to an embodiment;

FIG. 7 illustrates a dashboard according to an embodiment;

FIG. 8 (depicted as FIGS. 8A and 8B) illustrates a task workbench according to an embodiment;

FIG. 9 illustrates a structured analysis method according to an embodiment;

FIG. 10 (depicted as FIGS. 10A and 10B) illustrates a guided analysis path according to an embodiment; and

FIG. 11 illustrates a plan for action management according to an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

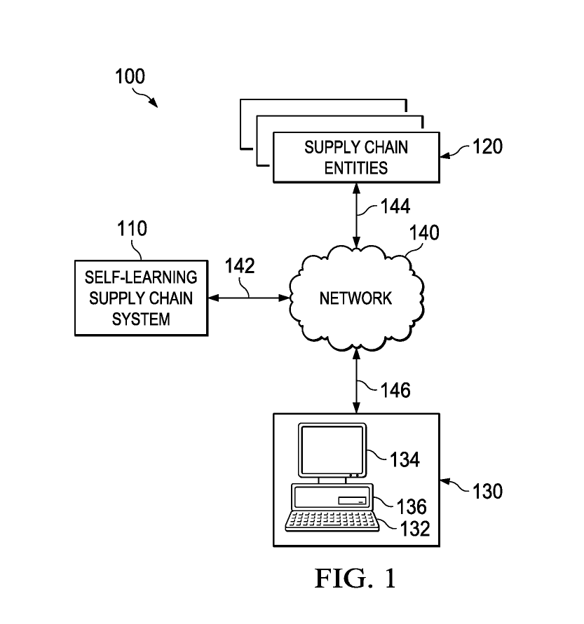

FIG. 1 illustrates an exemplary supply chain system 100 according to a preferred embodiment. Supply chain system 100 comprises self-learning system 110, one or more supply chain entities 120, computers 130, a network 140, and communication links 142, 144, and 146. Although a single self-learning system 110, one or more supply chain entities 120, a single computer 130, and a single network 140, are shown and described; embodiments contemplate any number of self-learning systems 110, any number of supply chain entities 120, any number of computers 130, or any number of networks 140, according to particular needs.

Supply chain system 100 operates on one or more computers 130 that are integral to or separate from the hardware and/or software that support self-learning system 110 and one or more supply chain entities 120. Computers 130 include any suitable input device 132, such as a keypad, mouse, touch screen, microphone, or other device to input information. An output device 134 conveys information associated with the operation of supply chain system 100, including digital or analog data, visual information, or audio information. Computers 130 include fixed or removable non-transitory computer-readable storage media, such as magnetic computer disks, CD-ROM, flash drive, in-memory device or other suitable media to receive output from and provide input to supply chain system 100. Computers 130 include one or more processors 136 and associated memory to execute instructions and manipulate information according to the operation of supply chain system 100.

Although a single computer 130 is shown in FIG. 1, self-learning system 110 and one or more supply chain entities 120 may each operate on separate computers 130 or may operate on one or more shared computers 130. Each of the one or more computers 130 may be a work station, personal computer (PC), network computer, notebook computer, personal digital assistant (PDA), tablet, cell phone, telephone, wireless data port, or any other suitable computing device. In an embodiment, one or more users may be associated with self-learning system 110. These one or more users may include, for example, a “supply chain manager” or “planner” handling resources, planning, and/or one or more related tasks within supply chain system 100. In addition, or as an alternative, these one or more users within supply chain system 100 may include, for example, one or more computers programmed to autonomously handle resources, planning, and/or one or more related tasks within supply chain system 100.

In one embodiment, one or more supply chain entities 120 represent one or more supply chain networks including one or more entities, such as, for example suppliers, manufacturers, distribution centers, retailers, stores, online stores, and/or customers. A supplier may be any suitable entity that offers to sell or otherwise provides one or more items to one or more manufacturers. Items may comprise, for example, products, parts, or supplies that may be used to generate products. An item may comprise a part of the product, or an item may comprise a supply that is used to manufacture the product, but does not become a part of the product, for example, a tool, energy, or resource. A manufacturer may be any suitable entity that manufactures at least one finished good. A manufacturer may use one or more items during the manufacturing process to produce a finished good. In this document, the phrase “finished good” may refer to any manufactured, fabricated, assembled, or otherwise processed item, material, component, good or product. A finished good may represent an item ready to be supplied to, for example, another supply chain entity in system 100, such as a supplier, an item that needs further processing, or any other item. A manufacturer may, for example, produce and sell a finished good to a supplier, another manufacturer, a distribution center, a retailer, a customer, or any other suitable person or entity. A distribution center may be any suitable entity that offers to sell or otherwise distributes at least one finished good to one or more retailers and/or customers. A retailer may be any suitable entity that obtains one or more finished goods to sell to one or more customers. According to one embodiment, entities 120 are internal or external to a supply chain. Typically, a supply chain receives supplies from one or more suppliers and provides products to one or more customers. A supply chain may include any suitable number of nodes and any suitable number of arcs between the nodes, configured in any suitable manner.

Although one or more supply chain entities 120 are shown and described as separate and distinct entities, the same person or entity can simultaneously act as any one of the one or more supply chain entities 120. For example, one or more supply chain entities 120 acting as a manufacturer could produce a finished good, and the same entity could act as a supplier to supply an item to another supply chain. Although one example of a supply chain network is shown and described, embodiments contemplate any operational environment and/or supply chain network, without departing from the scope of the present invention.

In one embodiment, self-learning system 110 is coupled with network 140 using communications link 142, which may be any wireline, wireless, or other link suitable to support data communications between self-learning system 110 and network 140 during operation of supply chain system 100. One or more supply chain entities 120 are coupled with network 140 using communications link 144, which may be any wireline, wireless, or other link suitable to support data communications between one or more supply chain entities 120 and network 140 during operation of supply chain system 100. Computers 130 are coupled with network 140 using communications link 146, which may be any wireline, wireless, or other link suitable to support data communications between computers 130 and network 140 during operation of supply chain system 100.

Although communication links 142, 144, and 146 are shown as generally coupling self-learning system 110, one or more supply chain entities 120, and computers 130 with network 140, self-learning system 110, one or more supply chain entities 120, and computers 130 may communicate directly or indirectly with self-learning system 110, one or more supply chain entities 120, and computers 130, according to particular needs.

In another embodiment, network 140 includes the Internet and any appropriate local area networks (LANs), metropolitan area networks (MANS), or wide area networks (WANs) coupling self-learning system 110, one or more supply chain entities 120, and computers 130. For example, data may be maintained by self-learning system 110 at one or more locations external to self-learning system 110 and one or more supply chain entities 120 and made available to one or more associated users of one or more supply chain entities 120 using network 140 or in any other appropriate manner. Those skilled in the art will recognize that the complete structure and operation of communication network 140 and other components within supply chain system 100 are not depicted or described. Embodiments may be employed in conjunction with known communications networks and other components.

In one embodiment, supply chain system 100 may provide a supply chain plan that describes the flow of items through one or more supply chain entities 120 or other supply chain planning environments associated with system 100. According to some embodiments, self-learning system 110 stores a supply chain plan as plan data 228 in supply chain planning database 220. As described below, self-learning system 110 may be used to continually adjust the supply chain plan to a state of feasibility and/or optimality due to problems in the supply chain plan inputs as the problems occur by using KPI monitors 216 and alerts 206 to monitor KPIs and data received from supply chain entities 120.

For example, the problems in the supply chain inputs may include, but are not limited to, new unforecasted orders, new orders, changes to existing orders or forecasts, changes to in-transit shipments, changes to work in progress or work in process, changes in inventory, new capacity, reduced capacity, changes to external supply, and the like. In addition, according to one example, these problems may be classified into categories such as, for example, supply changes, inventory changes, capacity changes, demand changes, and the like. Although example categories of problems are described, embodiments contemplate any type of disruptions, plan problems, perturbations, changes, events, or categories of disruptions, perturbations, changes, and/or events, according to particular needs. In this document, the terms “disruptions,” “problems,” “perturbations,” “changes,” or “events” may refer to any positive or negative deviation, condition, pattern, or occurrence within the supply chain plan or during execution of the plan that can motivate action by a supply chain planner.

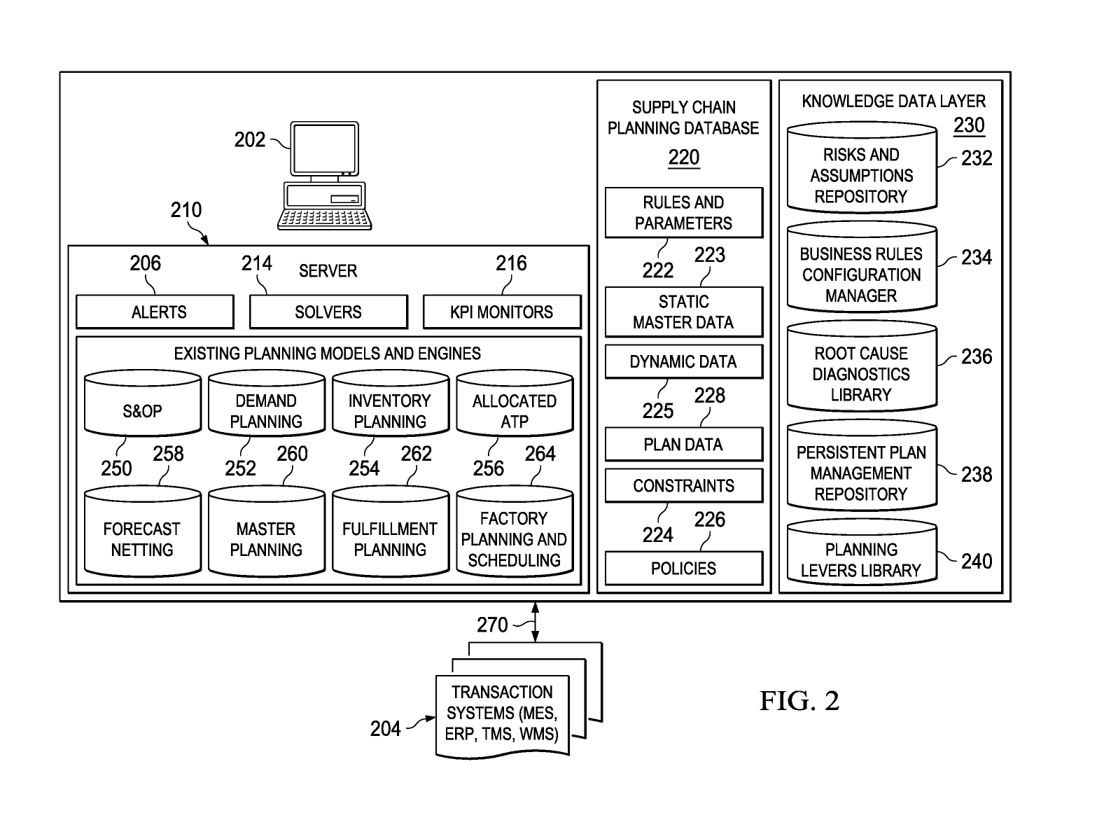

FIG. 2 illustrates self-learning system 110 of FIG. 1 in greater detail in accordance with an embodiment. Self-learning system 110 comprises computer 202, server 210, supply chain planning database 220, and knowledge data layer 230. According to some embodiments, self-learning system 110 is coupled to transaction systems 204 by network connection 270. Server 210 comprises one or more planning engines 212, alerts 206, key performance indicator (KPI) monitors 216, and solvers 214. Although server 210 is shown and described as comprising one or more planning engines 212, alerts 206, KPI monitors 216, and solvers 214, embodiments contemplate any suitable number or combination of these, according to particular needs. Furthermore, planning engines 212, alerts 206, KPI monitors 216, and solvers 214 of server 210 may be located at one or more locations, local to, or remote from, server 210 such as on multiple servers 210 or computers 202.

Supply chain planning database 220 and knowledge data layer 230 comprise one or more databases or other data storage arrangements at one or more locations, local to, or remote from, server 210. Supply chain planning database 220 and knowledge data layer 230 may be coupled with server 210 and each other using one or more LANs, MANs, WANs, network 140, such as, for example, the Internet, or any other appropriate wire line, wireless, or other links. Supply chain planning database 220 and knowledge data layer 230 store data that may be used by server 210 or each other. Supply chain planning database 220 may include, for example, rules and parameters 222, static master data 223, dynamic data 225, constraints 224, policies 226, and plan data 228. Knowledge data layer 230 may include, for example, risks and assumptions repository 232, business rules configuration manager 234, root cause diagnostics library 236, persistent plan management repository 238, and planning levers library 240.

Transaction systems 204 include manufacturing execution systems (MES), enterprise resource planning systems (ERP), transportation management systems (TMS), warehouse management systems (WMS), and the like. Transaction systems 204 may be coupled with computer 202, server 210, supply chain database 220, and knowledge data layer 230 using one or more LANs, WANs, MANs, network 140, such as, for example, the Internet, or any other appropriate wire line, wireless, or other links. In some embodiments, transaction systems 204 reside on server 210, computer 202, or are spread across one or more servers 210 or computers 202. Transaction systems 204 comprise control and coordination of various aspects of the production process including inputs, personnel, machines, and support services. In one embodiment, transaction systems 204 comprise business management software that stores and manages data from one or more supply chain entities 120 including product planning, research and development, manufacturing, marketing, sales, inventory management, shipping, and payment. In other embodiments, transaction systems 204 provide a real-time view of any business process, by using supply chain planning database 220 or server 210 to track business resources (e.g. cash, raw materials, production capacity, warehouse capacity, inventory etc.) and open commitments (e.g. orders, payroll).

Server 210 may support one or more planning engines 212 which may generate supply chain plans based on inputs received from one or more planners and/or supply chain planning database 220, as described more fully below. Plan data 228, within supply chain planning database 220, may include data reflecting supply chain plans generated by one or more planning engines 212 and may be used by planners within system 100, according to particular needs. In general, a planning cycle may include a supply chain planning session and a period of time separating the supply chain planning session from a subsequent supply chain planning session. However, embodiments contemplate a continuous planning cycle where generating, publishing, and executing a plan occur as part of an ongoing process, each of generating, publishing, and executing a plan not comprising discrete steps, but being inter-related to each other and continually updated as herein described by self-leaning system 110.

Self-learning system 110, and in particular, server 210, may store and/or access various rules and parameters 222, static master data 223, dynamic data 225, constraints 224, policies 226, and plan data 228, associated with one or more supply chain entities 120. As discussed above, self-learning system 110 may continuously adjust the supply chain plan to a state of feasibility and/or optimality due to disruptions in the supply chain by continually monitoring any type of data or KPIs using KPI monitors 216 or alerts 206 in order to update a plan as soon as data or KPIs received from supply chain entities 120 indicate that a disruption or plan problem has, will, or is likely to occur. Self-learning system 110 monitors data or KPIs by receiving such information from supply chain entities 120 and detecting out of range limits or patterns that indicate a supply chain plan problem using alerts 206 or KPI monitors 216.

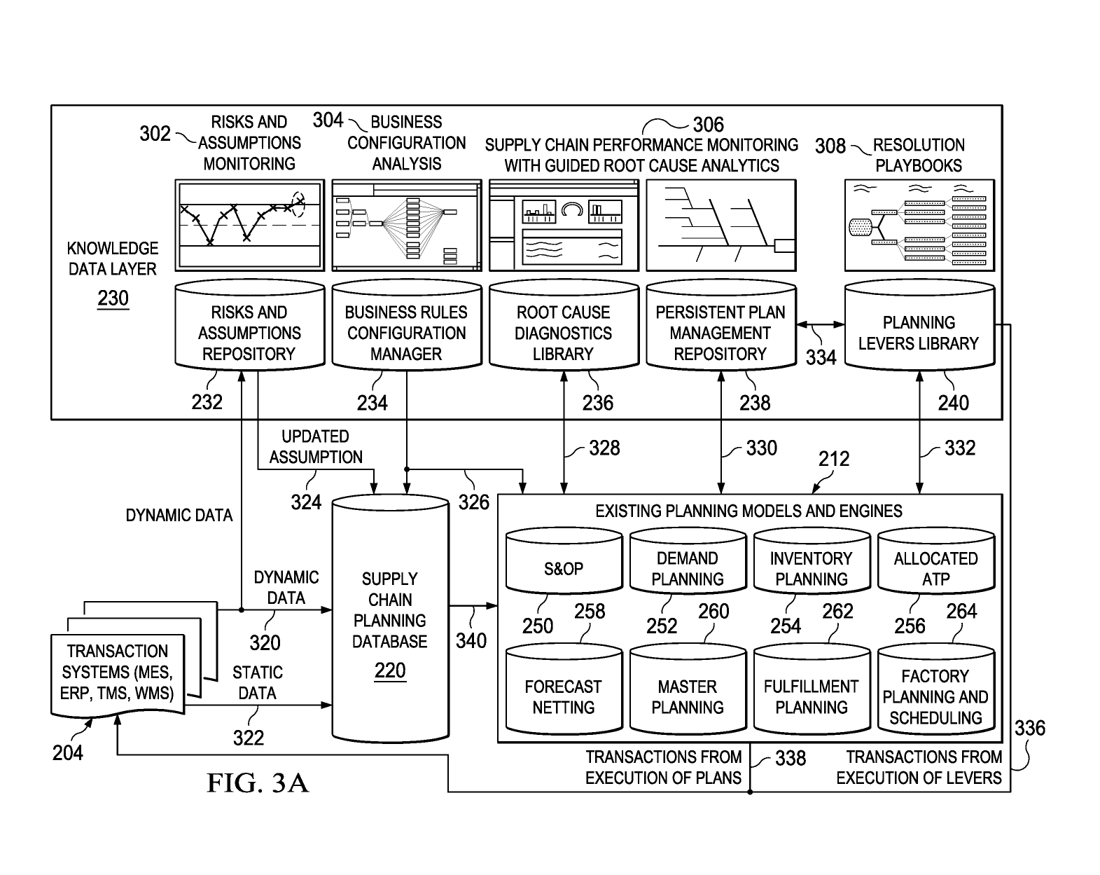

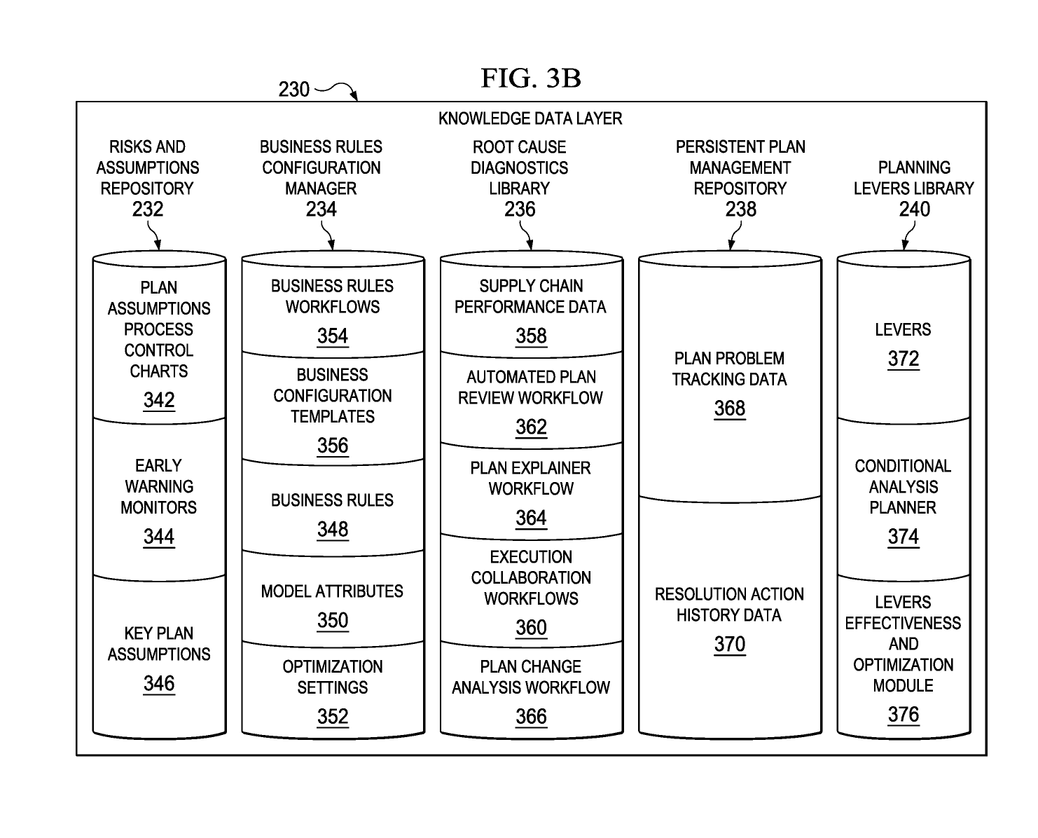

To further explain the operation of a self-learning supply chain, an example is provided. In the following exemplary FIG. 3A, self-learning system 110 of FIG. 2 is illustrated in greater detail in accordance with an embodiment. In the following exemplary FIG. 3B, knowledge data layer 230 of FIG. 2 and FIG. 3A is illustrated in greater detail in accordance with an embodiment. Self-learning system 110 enables a learning paradigm by coupling knowledge data layer 230 to transaction systems 204, supply chain planning database 220, and planning models and engines 212. Knowledge data layer 230 resides on one or more computers 202 and integrates with transaction systems 204, supply chain planning database 220 and planning models and engines 212 using communication links 320-340 to continuously capture institutional knowledge of one or more supply chain entities 120 and integrates that knowledge into future supply chain plans. In some embodiments, knowledge data layer 230 captures and integrates this institutional knowledge by, for example, utilizing at least one or more of the following databases and systems: risks and assumptions repository 232; business rules configuration manager 234; root cause diagnostics library 236; persistent problems repository 238; planning levers library 240; supply chain planning database 220; and integration interfaces to transaction systems 204. In one embodiment, institutional knowledge includes, but is not limited to, data that is generated, stored, or retrieved by knowledge data layer 230, as discussed in more detail below.

Risks and assumptions repository 232 utilizes one or both of plan assumptions process control charts 342 and early warning monitors 344 to detect and warn when supply chain plan assumptions and/or parameters deviate from a supply chain plan. As discussed above, a supply chain plan describes the flow of items, such as, for example, materials and products through one or more supply chain entities 120 or other supply chain planning environments associated with system 100. Process control charts 342 include any programs that monitor a supply chain process and detects unusual or abnormal values or patterns. According to one embodiment, process control charts 342 may comprise a trend for a particular KPI with upper and lower control limits defining the range of usual performance. Self-learning system 110 monitors risks and assumptions 302 via process control charts 270 and dynamically updates the assumptions based on data received elsewhere in self-learning system 110, such as from transaction systems 204 or supply chain entities 120. In some embodiments, plan assumptions process control charts 342 stored in risks and assumptions repository 232 comprise workflows utilizing six sigma process control concepts to monitor and/or manage key plan assumptions 346 including, for example, planned lead times, planned forecast errors, planned yields, planned prices, and planned uptimes. These key plan assumptions 346 may be stored in one or more databases for access by supply chain planning database 220 which may receive updated assumptions 324 based on data received risks and assumptions repository 232 based on analysis using process control charts 342, which have calculated the updated assumptions 324 based on data received from elsewhere in self-learning system 110, such as from transaction systems 204, and/or supply chain system 100.

According to some embodiments, risks and assumptions repository 232 also comprises early warning monitors 344. Early warning monitors 344 comprise workflows that configure alerts 206 of supply chain planning database 220 to monitor execution of supply chain plans. In some embodiments, these workflows detect known risks and root causes of supply chain plan problems including, e.g., unexpected orders, delayed shipments, yield drops, and price increases by integrating with early warning monitors 344 which monitor data and KPIs from transaction system 204 and supply chain entities 120. For example, rather than starting with a late order and identifying why the order is late, early warning monitors 344 permit a self-learning system 110 to identify the root cause of a plan problem as it happens; thereby quantifying its impact on all orders of one or more supply chain entities 120 affected by the plan problem. This permits a planner utilizing self-learning system 110 to receive an alert 206 identifying a root cause and view this alert 206 with all other alerts 206 so that various levers 372 are displayed on a display and reviewed, such that the best resolution is determined.

Business rules configuration manager 234 comprises a database that stores business rules workflows 354 or business configuration templates 356 which include, for example, business rules 348, model attributes 350, and optimization settings 352. Business rules configuration manager 234 provides for business configuration analysis 304 by providing a user interface to compute, monitor, and change any one of business rules 348, model attributes 350, and/or optimization settings 352. According to some embodiments, optimization settings 352 include group parameter maintenance and multi-dimensional segmentation, such as centrally across a supply chain management suite. Business rules configuration manager 234 is coupled with supply chain planning database 220 and existing planning models and engines 212 with communication link 326, however, business rules configuration manager 234 may communicate with other components of self-learning system 110 and/or supply chain system 100, accordingly to particular needs.

Root cause diagnostic library 236 comprises a database that stores (1) supply chain performance dashboard data 358, (2) execution collaboration workflows 360, (3) automated plan review workflow 362, (4) plan explainer workflow 364, and (5) plan change analysis workflows 366. Self-learning system 110 provides a planner supply chain performance dashboards 701 by calculating and displaying “Performance to Plan” metrics for production, sales, and/or inventory. In some embodiments, supply chain performance dashboards 701 determine guided analysis paths for augmenting supply chain performance dashboards 701, which enable a planner to identify root causes by navigating from metrics (including top level metrics) to root causes of performance deviations. Self-learning system 110 determines and displays execution collaboration workflows 360 by monitoring and logging published plan execution, which may be overridden by self-learning system 110 prior to accepting the published plan for execution. In some embodiments, execution collaboration workflows 360 track the time, place, reason, and/or manner that published plans are overridden, validate and refine plan assumptions, and reduce complexity from published plan compliance analysis. Among other things, automated plan review workflows 362, plan explainers workflows 364, and plan change analysis workflows 366 increase the speed of reviewing, understanding, approving, and publishing plans. Root cause diagnostics library 236 is coupled with existing planning models and engines 212 with communication link 328, however, root cause diagnostics library 236 communicates with other components of self-learning system 110 and/or supply chain system 100, accordingly to particular needs. In some embodiments root cause diagnostics library 236, persistent problems and work order management repository 238, or both store data to be displayed by self-learning system 110 for supply chain performance monitoring with guided root cause analytics 306.

Persistent problems and work order management repository 238 stores plan problem tracking data 368 and resolution action history data 370. Plan problem tracking data 368 comprises data from self-learning system 110, supply chain entities 120, and/or transaction systems 204 that provides self-learning system 110 to track supply chain plan problems and across lifecycles and planning cycles of a supply chain plan of one or more supply chain entities 120. Resolution action history data 370 comprises data from self-learning system 110, supply chain entities 120, and/or transaction systems 204 that provides self-learning system 110 to track the resolution of supply chain plan problems across lifecycles and planning cycles of a supply chain plan or one or more supply chain entities 120. The plan problem tracking data 368 and resolution action history data 370 stored in persistent problems and work order management repository 238 provides self-learning system 110 to perform an audit trail, which may include, when, where, and how problems with a plan originated, actions performed to solve a problem, and what occurred as a result of actions performed to solve supply chain plan problems. In some embodiments, persistent problems and work order management repository 238 comprises reconciliation of cumulative work order performance by, item, facility, and/or factory and comprises closed loop tracking of work orders across planning cycles. Persistent problems and work order management repository 238 utilizes data from supply chain planning database 220 and/or transaction systems 204 to generate reconciliation of a supply chain plan problem, which may generate status determinations of work orders. Status determinations include acknowledged, started, shipped, or the like. In addition, or as an alternative, persistent problems and work order management repository 238 may be utilized by self-learning system 110 to continuously monitor planning lead time assumptions in real time by monitoring delivery of work orders by product and/or facility. As an example only and not by way of limitation, self-learning system 110 tracks work orders using any supply execution module within a supply collaboration process. Persistent problems and work order management repository 238 is coupled with existing planning models and engines 212 with communication link 330 and to planning levers library 240 with communication link 334, however, persistent problems and work order management repository 238 may communicate with other components of self-learning system 110 and/or supply chain system 100, accordingly to particular needs.

The planning levers library 240 comprises a database of levers 372, a conditional analysis planner 374, and a lever effectiveness monitoring and optimization module 376. The library of levers 372 comprises a database of levers 372 that a planner may utilize to counteract consequences of plan problems of known or unknown risks.

Self-learning system 110 stores levers 372 in planning levers library 240. Levers 372 comprise workflows that automate corrective actions. For example and not by way of limitation, if the supply chain performance of one or more supply chain entities 120 is not aligned with the supply chain plan due to a late order, some potential resolutions include redirecting product from another order, splitting demand, and utilizing other workflows. Self-learning system 110 displays to a user one or more levers 372, which, when selected by a user, will enact one or more resolutions to the misalignment with the supply chain plan. In the example just mentioned comprising a misaligned supply chain plan due to a late order, the levers, when selected by a user, may redirect product from another order, split demand, and/or utilize an alternate workflow. Other corrective actions include, for example, expending material in transport, increasing the priority for a manufacturing lot, utilizing material from a first order to fulfill a second order, marking down products, expediting transportation, adding overtime to increase capacity, and offloading work to alternate resources.

In some embodiments, self-learning system 110 stores, for example in planning levers library 240, which lever 372 is most often selected to resolve a particular problem and the response of the supply chain entities 120 to that lever 372. In this way, self-learning system 110 may present to a user not only preconfigured resolution levers, but also information on which levers 372 have been utilized before, the effectiveness of using that lever, and which lever 372 may be most effective in different situations comprising a supply chain problem to one or more supply chain entities 120. Preconfigured resolution levers comprises levers which require little to no user input or configuration before executed. Embodiments contemplate a mixture of preconfigured resolution levers which require little or no input from a supply chain planner before execution and also other types and varieties of levers 372, which may allow for user customization prior to execution. Some levers 372 may be termed automatic because self-learning system 110 executes the lever 372 in response to a supply chain plan problem from one or more entities 120 without any user input. A non-limiting example of a lever 372 used to resolve a supply chain plan problem is now given.

For example only and not by way of limitation, if one of the one or more supply chain entities 120 has a supply problem with parts, for example, a late part, and the most appropriate lever 372 is to expedite an impending shipment by switching from a regular truck to a team truck, then self-learning system 110 exercises a lever 372 predetermined to be effective to resolve the supply chain problem or, alternatively, presents to a user the option to select a lever that will be effective to resolve the supply chain problem. In this example, the lever 372 would switch the supply of the part from a regular truck to a team truck. As part of the self-learning process, self-learning system 110 also monitors and stores in levers effectiveness and optimization module 376 data concerning the eventual delivery of the part, and how the switching of the delivery of the part from a regular truck to a team truck affects other orders in the supply chain. In this way, self-learning system 110 monitors, stores, and presents data concerning the effectiveness of using one or more levers 376 that would otherwise be lost or needed to be learned again. In some embodiments, self-learning system 110 monitors and stores data by levers effectiveness and optimization module 376 for one or more supply chain entities 120 concerning the tradeoffs that have been made in a situation. In this way, self-learning system 110 stores data about levers 372 that have been used previously and then retrieves the levers when the same or similar situation occurs again. In some embodiments, levers effectiveness and optimization module 376 presents the levers 376 in a structured way such that the most effective, most used, or highest priority levers are easily distinguishable to a user of self-learning system 110 from the less effective, less used, or lower priority levers. Self-learning system 110 may rank levers 372 based on these or other factors. Similarly, in some embodiments, when a problem is encountered, self-learning system 110 assigns a score to a lever 372 based on the effectiveness, frequency of use, highest priority, least disruptive, or other factor that may be useful in scoring a lever 372 to deal with a supply chain disruption of one or more supply chain entities 120. Self-learning system 110 then displays the levers to a user wherein the levers are ranked by score.

In some embodiments, planning livers library 240 comprises a conditional analysis planner 374 which is utilized by self-learning system 110 to evaluate feasibility and/or impact of utilizing a lever 376. In some embodiments, self-learning system 110 utilizes conditional analysis planner 374 to generate simulations of the utilization of one or more levers 372. The simulations compute and display the feasibility, impact, cost, or the like of implementing one or more levers 372 in resolution playbooks 308. In some embodiments, a levers effectiveness monitoring and optimization module 376 is utilized by self-learning system to generate reports in resolution playbook 308, which analyzes an effectiveness of one or more levers 376 and optimizes an association of one or more levers 376 with alerts 206. Levers effectiveness monitoring and optimization module 376 may comprise a list of levers 372 prioritized by a metric, e.g. feasibility, impact, cost, effectiveness, or the like. Planning levers library 240 is coupled with existing planning models and engines 212 with communication link 332 and to transaction systems 204 with communication link 336, however, planning levers library 240 may communicate with other components of self-learning system 110 and/or supply chain system 100, accordingly to particular needs.

Supply chain planning database 220 comprises supply chain data including, for example, static master data 223, dynamic data 225, and business rules and configuration parameters 222. In some embodiments, supply chain planning database 220 is a common central database. In some embodiments, static master data 223, dynamic data 225, and business rules and configuration parameters 222 are shared by existing planning models and engines 212 across a supply chain management suite. Supply chain planning database 220 is coupled with existing planning models and engines 212 with communication link 340, to transaction systems 204 with communication links 320 and 322, to risks and assumptions repository 232 with communication link 324, and to business rules configuration manager 234 with communication link 236, however, supply chain planning database 220 may communicate with other components of self-learning system 110 and/or supply chain system 100, accordingly to particular needs.

In some embodiments, transaction systems 204 comprise integration interface adaptors to integrate transaction systems 204 to knowledge data layer 230 (or directly to any of its subcomponents), supply chain planning database 220, and existing planning models and engines 212. Supply chain planning database 220 receives dynamic data 225 and static master data 223 from transaction systems 204 over communication links 320 and 322, respectively. Transaction systems 204 communicate dynamic data to risks and assumptions repository 232 over communication link 320, planning levers library 240 communicates transactions from execution of levers 336 to transaction systems 204 and existing planning models and engines 212 communicates transactions from execution of plans 338 to transaction systems 204.

Existing planning models and engines 212 comprise one or more of the following: sales and operation planning 250, demand planning 252, inventory planning 254, allocated available-to-promise 256, forecast netting 258, master planning 260, fulfillment planning 262, transportation planning, merchandize planning, assortment planning, and factory planning and scheduling 264.

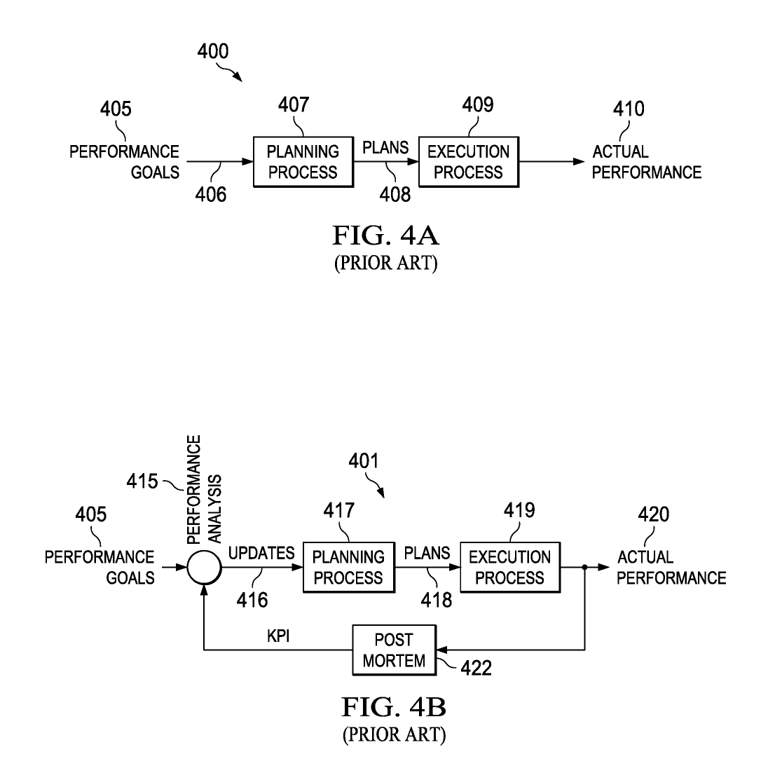

FIG. 4A-4B illustrate a traditional supply chain planning system 400. One of the problems with traditional supply chain planning system 400 of FIG. 4A is that it assumes business problems are solved once an optimal supply chain plan of one or more supply chain entities 120 is published for execution and that it is designed to create new supply chain plans with refreshed data. This results in an open loop control approach. Specifically, traditional supply chain planning system 400 begins with performance goals 405. After goals have been set, the goals are incorporated 406 into planning process 407. Planning process 407 generates plans 408 incorporating assumptions about known supply chain disruption events. Next, plans 408 are incorporated into execution process 409, which leads to actual performance 410, but only in the manner of a traditional supply chain planning system. Therefore, when disruptive events occur, the process begins again from performance goals 405 or planning process 407. Over time, traditional supply chain planning systems 400 become stale, misaligned, or useless. Some traditional supply chain planning systems 400 incorporate formal or informal post-mortems 422 (FIG. 4B (prior art)); however, such an approach is merely reactive at best.

A traditional supply chain planning system with post-mortem analysis 401 begins with performance goals 405. Next, an optional performance analysis 415 incorporates information learned from post-mortem 422. Any information from post-mortem is included in updates 416 which may be incorporated into the planning process 417. The planning process generates plans 418 which are then executed 419. Actual performance 420 generates results of the plan which may be looked at from time-to-time by a human planner. If a significant deviation 421 from the plan 418 results, the planner has the option to conduct a post-mortem 422. From the post-mortem 422, KPIs are identified 423 which are then incorporated into the performance analysis 415 which leads to updates 416 into subsequent cycles of the planning process 417.

However, the traditional supply chain planning system with post-mortem analysis 401 only conducts a post mortem loop 421, 422, 423 after a significant deviation from a supply chain plan attracts the attention of someone with authority to order closer scrutiny. The traditional post mortem 422 results in a knee jerk change in policy. A new set of rules is imposed in updates 416 and is enforced, even after the reasons for the changes have ceased to exist.

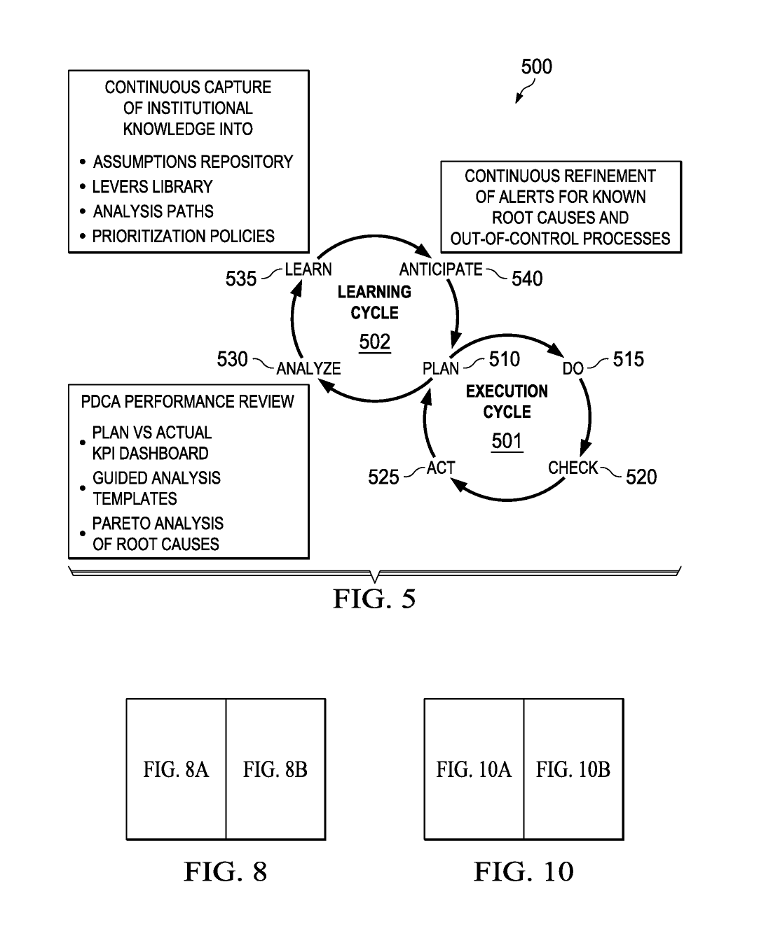

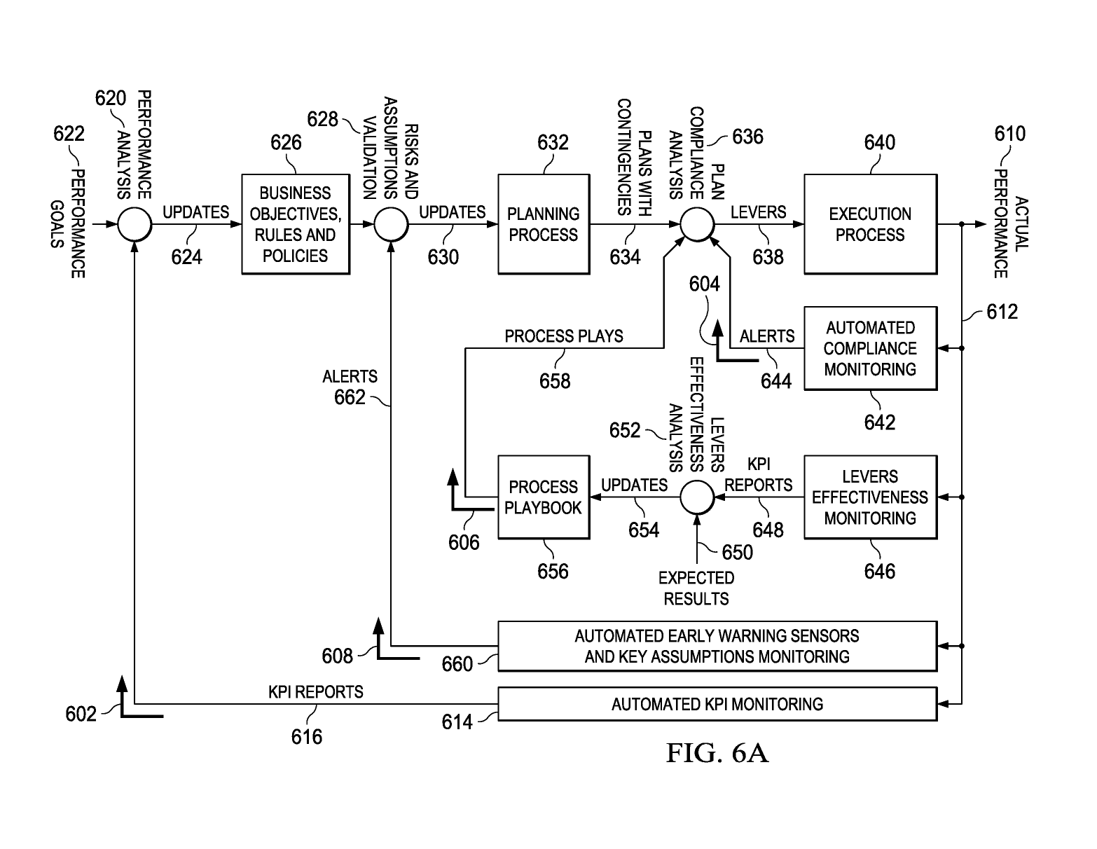

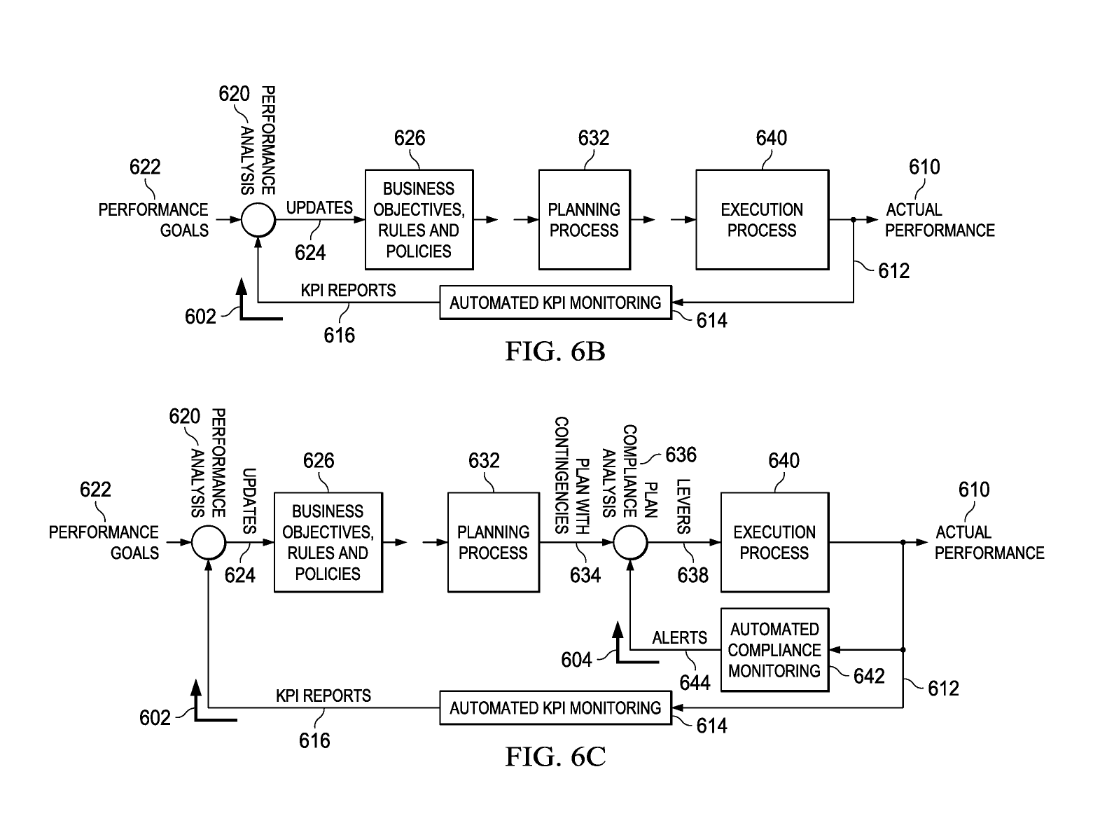

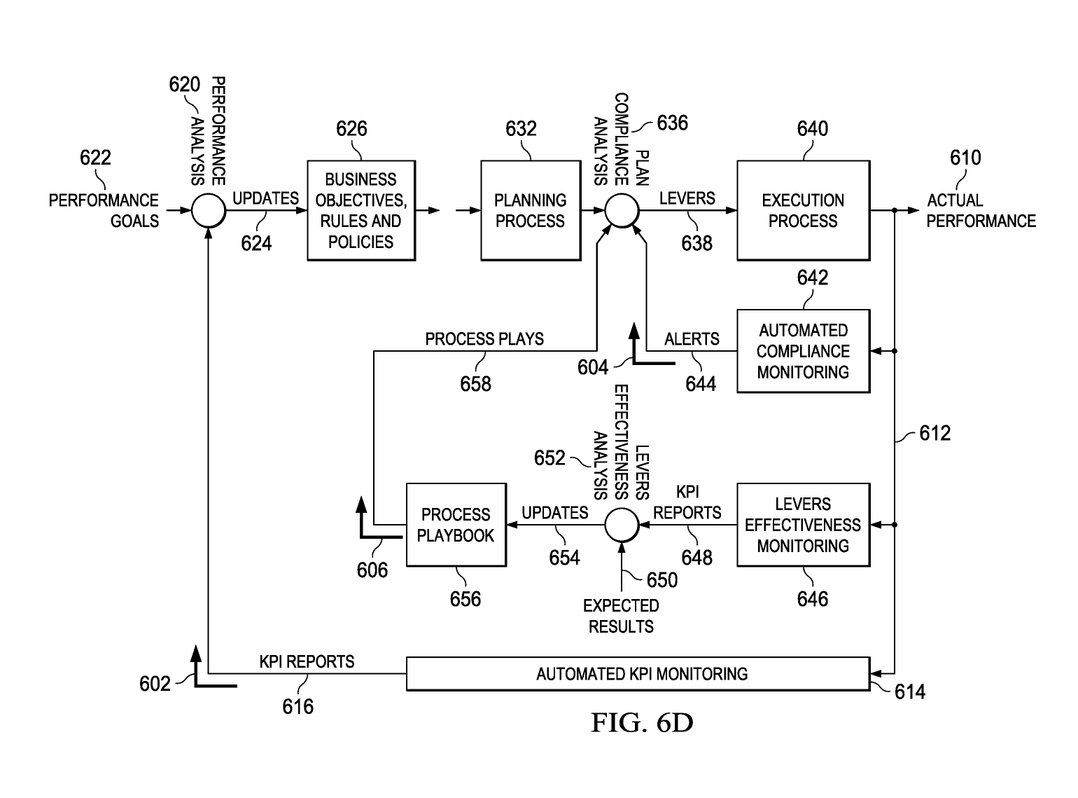

FIG. 5 illustrates a closed loop control process paradigm 500 comprising a learning cycle process 502 that augments an execution cycle process 501 according to embodiment. Self-learning system 110 enables continuous learning by closed loop-based support from a closed loop control process 500 as explored in more detail in FIGS. 6A-6D. In some embodiments, self-learning system 110 accumulates data in the knowledge data layer 230 (as explained above) across one or more execution cycle processes 501. An execution cycle process 501 is also known as a plan-do-check-act cycle (PDCA cycle).

Each execution cycle 501 comprises four steps: plan 510, do 515, check 520, and act 525. After the last step, act 525, the cycle begins again with plan 510.

Each learning cycle 502 comprises four steps: plan 510, analyze 530, learn 535, and anticipate 540. After the last step, anticipate 540, the cycle begins again with plan 510.

Self-learning supply chain system 110 uses rules to solve, monitor, and analyze performance across PDCA cycles. In some embodiments, this validates and refines planning assumptions on an ongoing basis. Learning cycle process 502 comprises updates, refinements, and reconfiguration of the assumptions, business rules, and planning models. Learning cycle process 502 replaces unknown unknowns with known unknowns, which may thereby incorporate contingencies into a supply chain plan. An unknown unknown is a supply chain disruption that a planner is not aware might occur. A known unknown, by contrast, are those supply chain disruptions which are known to occur, even if the timing or extent of the disruption is unknown ahead of time. The learning cycle process 502 compiles information from self-learning supply chain system 110 to generate contingency plans for supply chain disruptions which were not known to occur by storing, for example, the types of levers used to overcome the supply chain disruption and the effects the levers had in remedying the disruption. These solutions to supply chain disruptions comprise risk management, adaptability, agility, and continuous alignment of business objectives and ongoing execution.

Self-learning system 110 reconfigures rules and parameters 222 across a supply chain management software suite using, for example, industry and business model-specific templates and wizards. Self-learning system 110 also provides assessment of risks and contingency plans incorporated into plan data 228. Self-learning system 110 automates decision support workflows and prioritizes and resolves supply chain disruptions or one or more supply chain entities 120.

As shown above, self-learning supply chain system 110 executes a process that redefines a supply chain management problem from generating optimal plans to that of driving optimal performance using supply chain plans as a control signal and a plurality of monitored KPIs that provide closed loop feedback. In an embodiment, self-learning system 110 couples each PDCA cycle to a learning cycle process 502. That is, self-learning system 110 measures the performance of one or more supply chain entities 120 in the supply chain. As an example only and not by way of limitation, in an example where KPI is measuring inventory of an item at one or more supply chain entities 120, and the planner wishes to adjust the inventory of the item, self-learning system 110 determines whether or not satisfactory inventory levels are being achieved by displaying to the planner the levels of the item at the one or more supply chain entities 120 likely to be achieved and actually achieved by each action taken by the planner.

Self-learning system 110 continuously refines many factors to drive superior performance on an ongoing basis, to enable self-learning. Factors include, for example, assumptions, models, business rules, diagnosis paths, levers, resolution paths, and performance scorecards.

FIG. 6A-6D illustrate a closed loop plan 600 of self-learning system 110. Unlike traditional supply chain planning systems 400 and 401, closed loop plan 600 comprises proactive learning with closed loop control wherein each plan-do-check-act cycle PDCA cycle 501 is coupled to a learning cycle 502. In this manner, planning assumptions are continuously validated and refined, risks for disruptions are anticipated, and contingencies are planned for.

Self-learning system 110 comprises a plurality of closed loop performance monitoring systems 602, 604, 606, and 608. These systems strategically mine relevant data generated during the normal course of business of one or more supply chain entities 120 and use this data to provide early detection of deviations from a supply chain plan, validate assumptions, expand and assess options, and improve performance. Early detection is provided by early warning sensors that detect risks, in real-time, thereby providing notification to generate contingency plans. In this manner, each monitoring system may be used to generate continuous feedback, thereby providing a supply chain planner the ability to adjust one or more supply chain parameters and validate how adjustment of a parameter affects other goals of a supply chain plan. Each closed loop of FIG. 6A will be discussed in the following FIGS. 6B-6D.

FIG. 6B illustrates a performance analysis with KPI monitoring loop 602 of a self-learning system 110. In contrast to the reactive planning with post mortems of FIG. 4B, performance analysis with KPI monitoring loop 602 incorporates automatic KPI monitoring 614 and report generation 616 directly back into a performance analysis 620 during each iteration of a supply chain plan or at any specified time period. Traditional post mortems 422 are conducted sporadically and reactively only after an unfavorable outcome. In other words, self-learning system 110 expects a post mortem and performs one every time self-learning system 110 generates a supply chain plan such that automated KPI monitoring 614 is built into the process of planning and execution.

Self-learning system 110 automatically measures one or more KPIs by monitoring the actual performance 610 of a supply chain of one or more supply chain entities 120, for example with KPI monitors 216 that monitor data received from transaction systems 204. KPIs may be selected ahead of time by a planner or automatically by self-learning system 110 and the data may be stored in one or more databases, for example supply chain planning database 230 or in knowledge data layer 230. These KPIs are then compared to preset goals, which are selected by either a planner or self-learning system 110. Self-learning system 110 then generates KPI reports 616. A planner or self-learning system 110 conducts a performance analysis 620 by comparing the KPI reports 616 with the performance goals 622, and a planner or self-learning system 110 updates the supply chain plan immediately or any time before the next plan is generated.

By way of a non-limiting example, if supply chain planner sets a goal for one or more supply chain entities 120 as a 95% fill rate with 35 days of inventory, automated KPI monitoring 614 will determine if one or more supply chain entities 120 is actually achieving this goal by monitoring the KPIs, e.g. fill rate and days of inventory. If actual performance is underperforming, such as, for example, 37 days of inventory and a 90% fill rate, a KPI report 616 indicates the underperformance. Automated KPI monitoring 614 determines that the days of inventory are lower than the goal. Automated KPI monitoring 614 determines low inventory is caused by not enough inventory being stocked initially, and automated KPI monitoring 614 indicates this fact in KPI report 616.

FIG. 6C illustrates an embodiment of an automated compliance monitoring loop 604 in a self-learning system 110. An automated compliance monitoring loop 604 monitors if supply chain plans generated by self-learning system 110 are being implemented in execution or if the supply chain plans have been circumvented or overridden.

In automated compliance monitoring loop 604, actual performance 610 generates data 612 which is fed into automated compliance monitoring module 642. Automated compliance monitoring 642 generates alerts 644 in response to deviations from a supply chain plan of self-learning system 110. Alerts 644 are integrated into plan compliance analysis 636. Plan compliance analysis 636 compares the plan with contingencies 634 and alerts 644 to compare deviations. Automated compliance monitoring 642 monitors any deviations from the supply chain plan. In one embodiment, automated compliance monitoring 642 indicates large deviations from the supply chain plan. In other embodiments, automated compliance monitoring 642 indicates when the supply chain plan was first deviated from. This indication of timing is important because timing aids in identifying what caused the supply chain plan to deviate and what actions may be effective in remedying the deviation now or in future iterations of the supply chain plan. Automated compliance monitoring 642 optionally monitors KPIs, such as, a first alert that a deviation from a supply chain plan may be occurring, which is recorded and becomes part of the learning process. Thus automated compliance monitoring 642 provides for automatic capturing and mining of the data utilized in the learning process of self-learning system 110.

FIG. 6D illustrates an embodiment of a levers effectiveness monitoring loop 606 in a self-learning system 110. In one embodiment, supply chain managers utilize different options, or levers, to adjust to remedy supply chain disruptions of one or more supply chain entities 110 as the disruptions occur. According to some embodiments, the levers effectiveness monitoring loop 646 comprises self-learning system 110 monitoring the effectiveness and frequency of each choice of lever or levers and the utility of each lever and storing that data in planning levers library 240. This capturing of institutional knowledge improves over the normal course of running the self-learning system 110.

The levers effectiveness monitoring 646 receives data 612 about actual performance 610. The levers effectiveness monitoring 646 generates KPI reports 648 that are compared with an expected result 650 by levers effectiveness analysis 652 to see if the levers are effective or if they rectify the deviations from the supply chain plan. The comparison is used as updates 654 which are stored in a process playbook 656. In some embodiments, the process playbook 656 stores the effectiveness and use of various levers. In some embodiments, the process playbook 656 indicates to a supply chain manager which levers to use in which situations. In some embodiments, process playbook 656 indicates to a supply chain manger how to most effectively use a lever when a supply chain plan is being deviated from. This results in one or more process plays 658 which are fed back into plan compliance analysis 636. In some embodiments, the supply chain plan is then updated in further iterations, or the supply chain plan is more effectively complied with in the current iteration by receiving feedback while still being executed.

Levers effectiveness monitoring 646 determines when a lever is exercised, and whether the lever results in the desired and expected change. For example, some use of levers may be ineffective if the result of the lever is maxed out. Levers effectiveness monitoring 646 monitors whether a lever is ineffective if, for example, the lever cannot cause any more change in rectifying deviations from a supply chain plan because the lever is, for example, maxed out. In this manner, levers effectiveness monitoring 646 measures every lever for ability to rectify deviations from a supply chain plan. By way of a non-limiting example, suppose a supplier needs to use a lever for increasing the speed of a shipment. If the supplier chooses to use a next day delivery service from a first parcel shipment service and the parcel does not arrive the next day, levers effectiveness monitoring 646 will generate a KPI report 648 that indicates that the next day delivery service from the first parcel shipment service was an ineffective lever. Levers effectiveness monitoring 646 also indicates when the shipment was received. In this manner, a supply chain manager has the option to choose to use a second parcel shipment service in the future, and levers effectiveness monitoring 646 indicates a comparison between the two parcel shipment services to see which is more effective at shipping a parcel for arrival the next day. In addition, or as an alternative, levers effectiveness monitoring 646 also monitors the cost associated with choosing one or more levers and monitor effectiveness in a cost/benefit manner.

In some embodiments, process playbook 656 provides step-by-step guidelines that indicate what actions to take, e.g., which levers to use when certain events occur. As an example only and not by way of limitations, a computer supplier may have a process play 658 indicating that they will ship a computer quicker if a customer pays for premium shipping. Another example of a process play 658 may provide that, if a computer supplier is running low on inventory, e.g., a 14-inch monitor, the playbook may provide to offer another item for the same price, e.g., a 15-inch monitor for the same price as a 14-inch monitor.

Referring back to FIG. 6A, an overview of self-learning system 110 is illustrated with each of the above mentioned loops integrated into a single embodiment. FIG. 6A also illustrates automated early warning sensors and key assumptions monitoring loop 608. In some embodiments, automated early warning sensors and key assumptions monitoring loop 608 compares data 612 from actual performance 610 to assumptions built into the risks and assumptions repository 232. Based on the comparison, assumptions in the supply chain plan are updated according to actual performance 610 of the supply chain of one or more supply chain entities 120 based on the assumptions. If the comparison indicates that an assumption is no longer valid, automated early warning sensors and key assumptions monitoring 660 generates an alert 662 which is integrated into the risks and assumptions validation 628. The risks and assumptions validation 628 receives business objectives, rules and policies 626 and integrates the updated assumptions or assumption alerts 662 to generate updates 630 to planning process 632. In this manner, with each iteration of self-learning system 110, the automated early warning sensors and key assumptions monitoring 660 generates learning from measuring whether assumptions are still valid and updates the supply chain plan accordingly. The automated early warning sensors and key assumptions monitoring 660 checks the supply chain plan assumptions by determining whether the assumptions still remain valid. By way of a non-limiting example, if the supply chain plan assumes that the yield of some process is 95%, but the actual performance 610 indicates that the yield is actually 80%, the automated early warning sensors and key assumptions monitoring 660 indicates the assumption is invalid and issues an alert 662. In some embodiments, automated early warning sensors and key assumptions monitoring 660 also provides for monitoring the key assumptions and using statistical process control charts and the like to issue an early warning

As an example only and not by way of limitation, assuming that there is a two week lead time between the date that material is ordered and the date that it is received from the supplier (which may be a negotiated agreement); then plans are made which rely on having material available two weeks after ordering. However, if based on actual execution, monitoring reveals that the lead time has degraded to two and one-half weeks, automated early warning sensors and key assumptions monitoring 660 raises an alarm that an assumption has been violated. In response, self-learning system 110 uses an updated two and one-half week delivery assumption and/or flags the need to work with the supplier to resolve the issue long term. In some embodiments, self-learning system 110 persists and mines historical data. In some other, self-learning system 110 uses external data to supplement historical data. In addition, or as an alternative, self-learning system 110 monitors those assumptions and attempts to confirm that those assumptions remain true. If any of the assumptions are false, the supply chain plans generated by the planning model stored in risks and assumptions repository 230 or supply chain planning database 220 will be out of date and inaccurate and self-learning system 110 may adjust the assumptions to correspond to the true value.

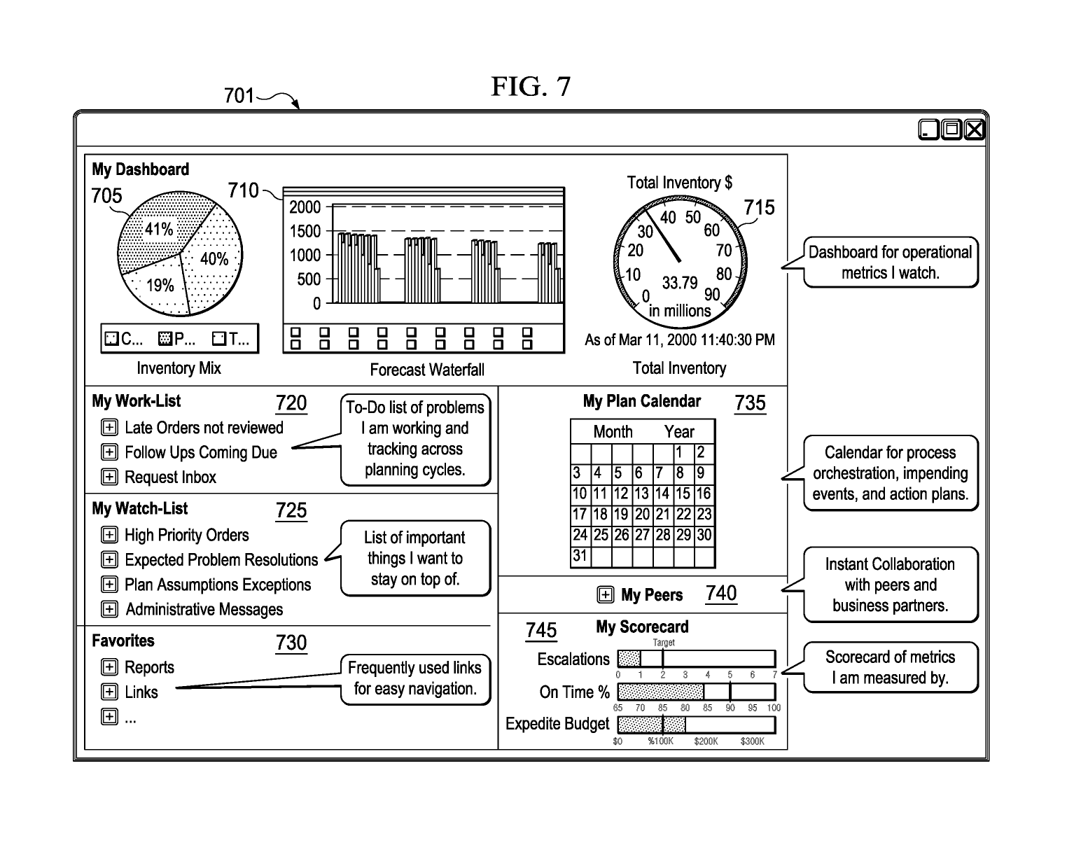

FIG. 7 illustrates dashboard 701 to monitor the performance of self-learning system 110, according to an embodiment. In some embodiments, dashboard 701 is tailored to each planner's role and the set of tasks needs to be accomplished throughout the execution cycle process 501. Dashboard 701 comprises KPIs and one or more of work-lists 720, watch-lists 725, favorites 730, plan calendars 735, instant collaboration links to peers 740, and performance scorecards 745. The KPIs are represented by charts 705, 710, and 715 which summarize one or more operational metrics of the supply chain that the planner is tracking. Embodiments contemplate any number or combination of any metrics, charts, or KPIs, according to particular needs.

Work-list 720 comprises a list of tasks assigned or owned by the planner. Self-learning system 110 sorts work list 720 in order of triage priority configured by the planner based on task severity, urgency, status and other criteria. Watch-list 725 comprises a list of tasks, such as, for example, the progress of specific orders, expedited lots, critical resources, projects, and the like. Favorites 730 comprise links to reports or workflows that a planner may use frequently. Plan calendar 735 comprises highlights of various events along a timeline such as, for example, process events i.e., when the next planning cycle will be run, to-do list events i.e., when certain tasks are due, or plan related events i.e., when a closely watched lot is scheduled to be shipped out from an outsource manufacturer. Instant collaboration links to peers 740 comprise a list of key stakeholders and peers the planner collaborates with frequently. Instant collaboration links to peers 540 is not to be confused with an instant messaging application. Instant collaboration links to peers 540 comprises collaboration on planning tasks where a planner is sharing a collaboration screen with a peer and juggling plans. Performance scorecards 745 comprise a list of KPIs specific to a planner's individual performance, such as, for example the number of escalations, spending relative to budget, timeliness on projects, and the like.

In one embodiments, performance scorecards 745 and/or KPI charts 705, 710, and 715 provide a view of data generated from closed loop control systems, which enables a view of planning and execution of a supply chain plan that redefines the problem from generating optimal supply chain plans to that of driving optimal performance using supply chain plans as a control signal. In other embodiments, performance scorecards 745 and KPI charts 705, 710, and 715 enable the monitoring of supply chain performance of one or more supply chain entities 120 against business objectives to be used as an error signal in a feedback control system. In this manner, measurements are quantified precisely and displayed. In some embodiments, an important component of the overall solution relates to metrics that actually feed into a closed loop control system to facilitate optimal performance. In some embodiments, these metrics are displayed by scorecards 745 and/or KPI charts 705, 710, and 715. In some embodiments, feedback data gathered from the execution plans provides the planner a performance scoreboard 745 or KPI charts 705, 710, and 715 to monitor whether key assumptions are valid.

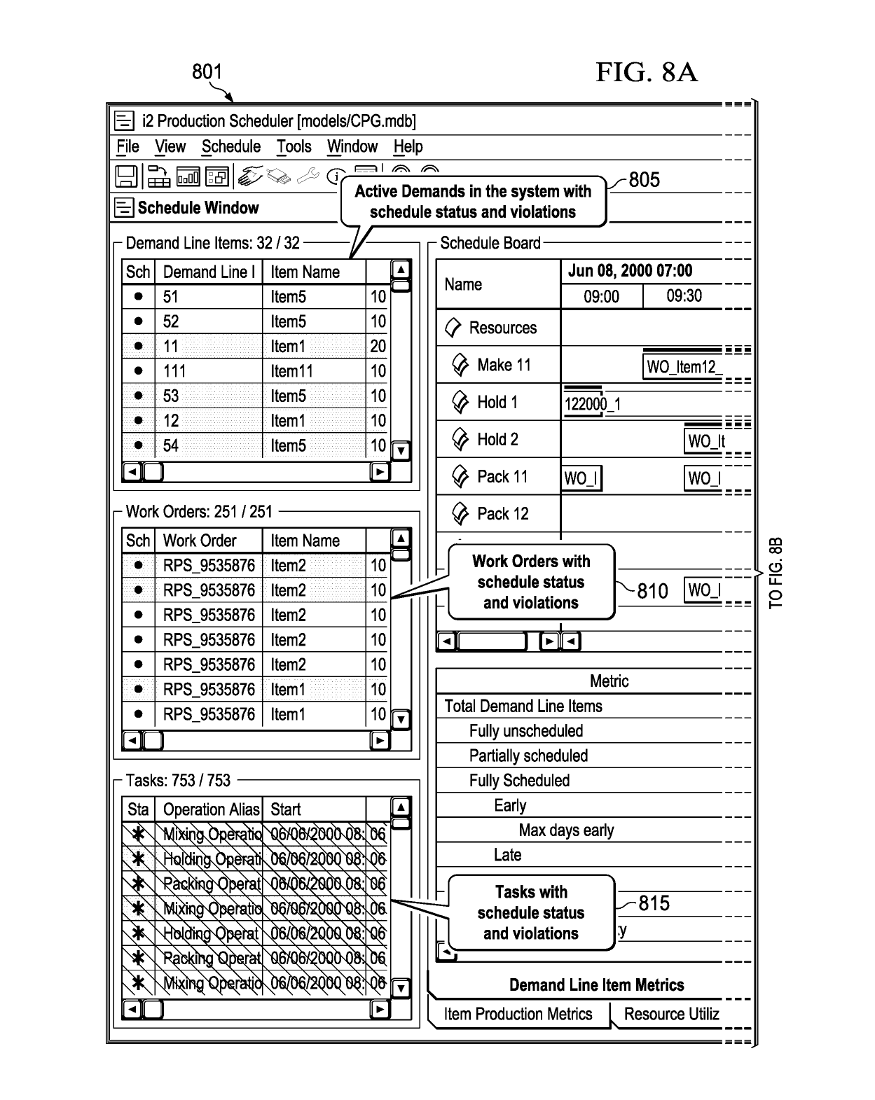

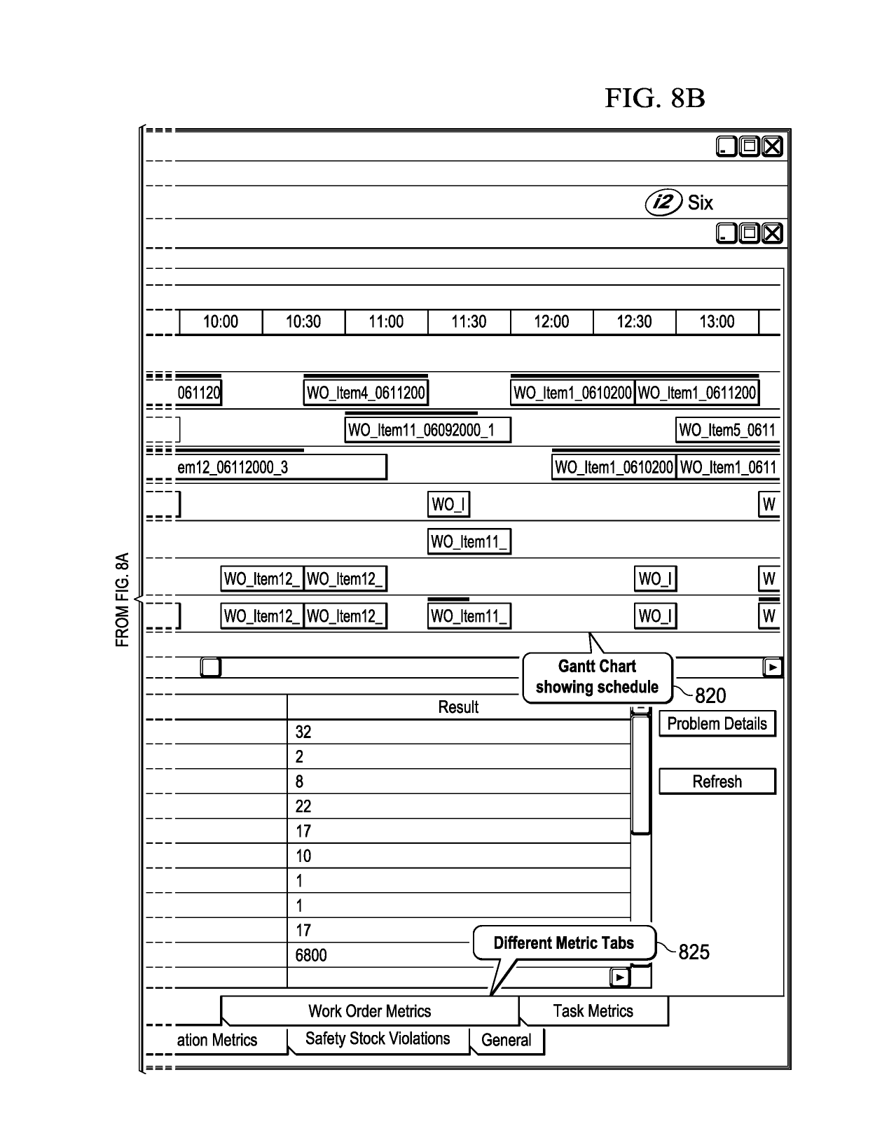

FIG. 8 (depicted as FIGS. 8A and 8B) illustrates a task workbench 801 according to an embodiment. According to embodiments, task workbench 801 provides a planner a user interface to review and edit a factory schedule. In some embodiments, a planner completes his or her review of the solver generated schedule, edits tasks, manually adjusts the schedule and resolves problems without ever leaving the schedule board. In some embodiments, task workbench 801 displays active demands in the system with schedule statuses and violations 805, work orders with schedule statuses and violations 810, tasks with schedule statuses and violations 815, Gantt chart showing schedule 820, different metric tabs 825, or a combination of the like.

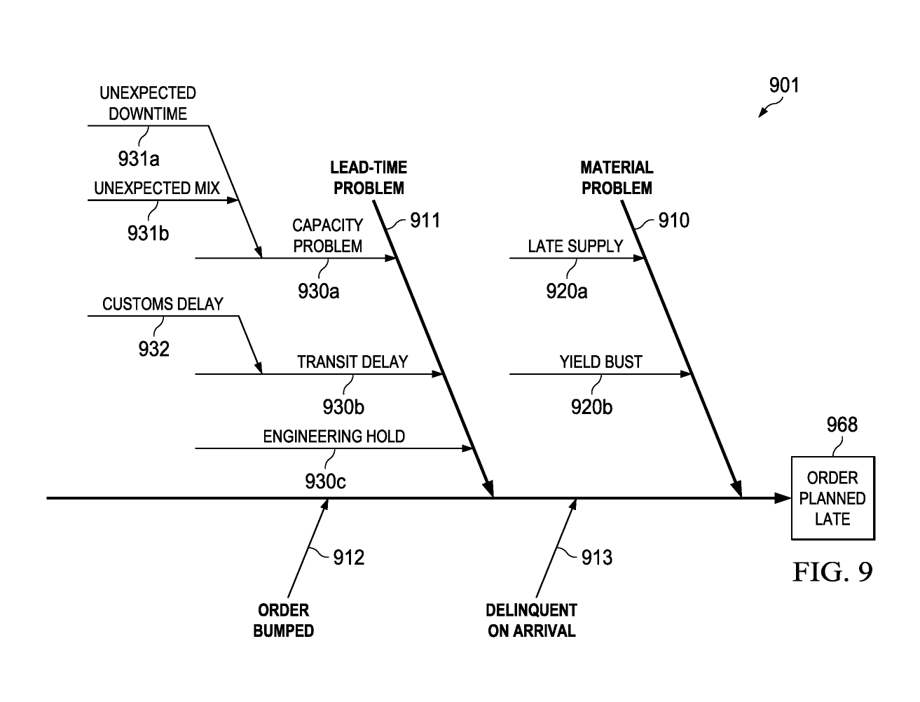

FIG. 9 illustrates a fishbone chart 901 as used in a structured analysis method to capture likely failure patterns in software models, according to an embodiment. In some embodiments, a structured analysis method to capture likely failure patterns comprises accumulating and refining root-cause analysis maps based on actual history. In some embodiments, the structured analysis method utilized is a fishbone chart 901. To begin this analysis, an effect 905 is chosen, and then all the known potential reasons 910-913 for this effect 905 are listed. For the effect 905, order planned late, four potential reasons are listed: material problem 910, lead-time problem 911, order-bumped 912, and delinquent on arrival 913. Each potential reason 910-913 is iteratively further broken down into sub-reasons going deeper into the fishbone chart 901. In the illustrated embodiment, material problem 910 is broken down into sub-reasons late supply 920a and yield bust 920b; and lead-time problem 911 is broken down into sub-reasons capacity problem 930a, transit hold 930b, and engineering hold 930c. In some embodiments, sub-reasons are broken down into further sub-reasons. By way of illustration and non-limiting example, a transit delay 930b is broken down to a customs delay 932; and capacity problem 930a is broken down by unexpected downtime 931a and unexpected mix 931b. In one embodiment, various levels of reasons are diagramed. By way of a further non-limiting example, if the failure pattern is that the product is not ready to ship when promised, the structured analysis depicts common problems causing the failure pattern. For example, two reasons might be a material problem or a resource problem. In some embodiments, a self-learning system 110 analyzes the next level, or sub-reason. In some embodiments, the self-learning system 110 then lists common sub-reasons for a material problem or resource problem and rank the sub-reasons according to likelihood of being the cause of the product not ready to ship when promised.

In some embodiments, self-learning system 110 lists known unknowns on a fishbone chart 901. In some embodiments, potential reasons execution of a supply chain plan deviates from the plan are known from previous data. For example, in some embodiments, data accumulated from the actual performance 610, automated compliance monitoring 642, levers effectiveness monitoring 646, automated early warning sensors and key assumptions monitoring 66, automated KPI monitoring 614, or a combination of the like are used to generate potential reasons execution of a supply chain plan deviates from the plan. In some embodiments, fishbone chart 901 documents current knowledge by listing known sources, or suspected sources, of deviations from a plan, which enables a planner to efficiently check of sources, or suspected sources, to quickly identify which are responsible for a deviation from the supply chain plan.

In some embodiments, self-learning system 110 enables early detection of sources, or suspected sources, of risk and capitalizes on opportunities to start proactively detecting the sources to maximize available reaction time. For each problem that may arise in execution of a supply chain plan, self-learning system 110 looks at the earliest possible detection of the problem and places one or more sensors to monitor the likely sources for the problem. In some embodiments, this increases lead time available to respond to a problem. In some embodiments, sensors detect the emergence of an identified risk to the supply chain plan. In this manner, contingency plans are implemented as quickly as possible. By way of a non-limiting example, when the weather service starts seeing the right amount of moisture accumulating in the ocean, a risk is identified that the weather system is likely to generate a storm in a few days. In a similar manner, a structured analysis method of self-learning system 110 captures likely failure patterns and accumulates and refines root cause analysis maps based on historical data.

In some embodiments, historical data and domain knowledge are used to develop and memorialize structured resolution paths that are shown to be most effective for each type of exception in each segment of the supply chain of one or more supply chain entities 120. In some embodiments, self-learning system 110 uses history to develop a structured resolution. As an example only and not by way of limitation, self-learning system 110 uses a fishbone chart 901 to create a graphic display that connects a particular cause or fork to the root cause. In some embodiments, self-learning system 110 determines which cause or fork has been exercised most often and may record numerically the strength of that connection. In some embodiments, when represented as a fishbone chart 901, one path would be darker than other paths because it has been used more frequently than other paths.

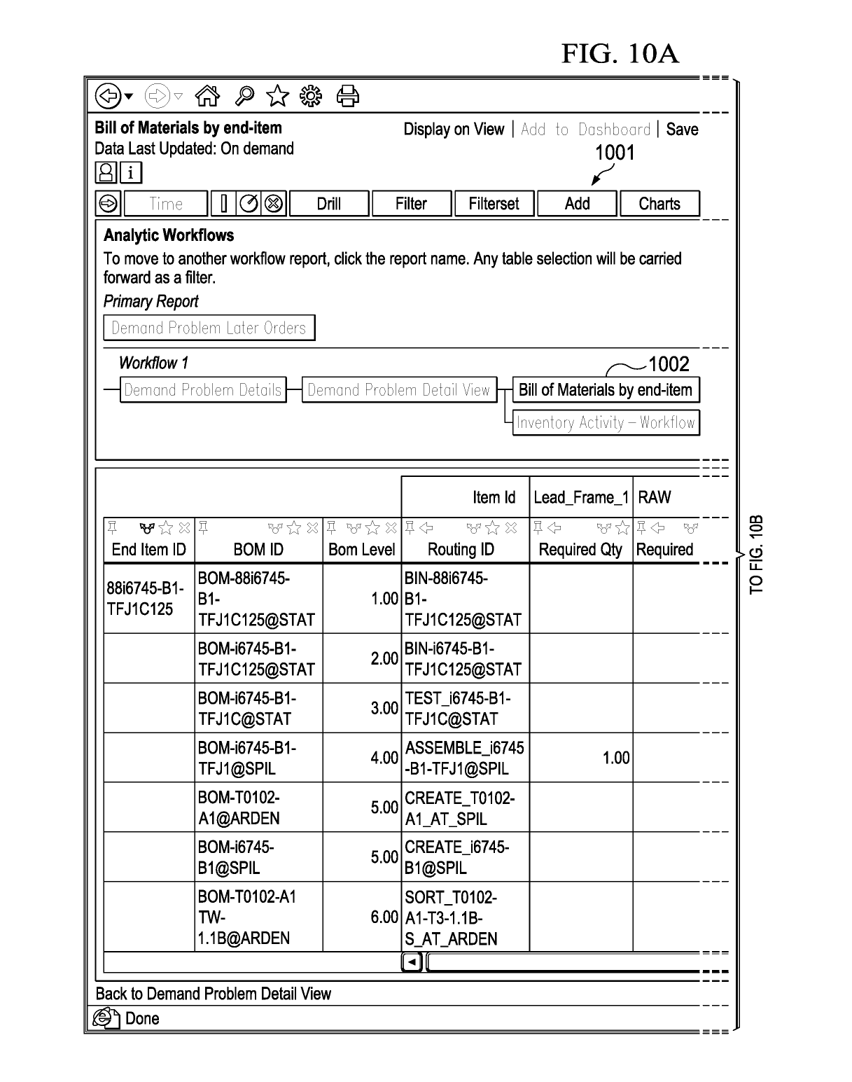

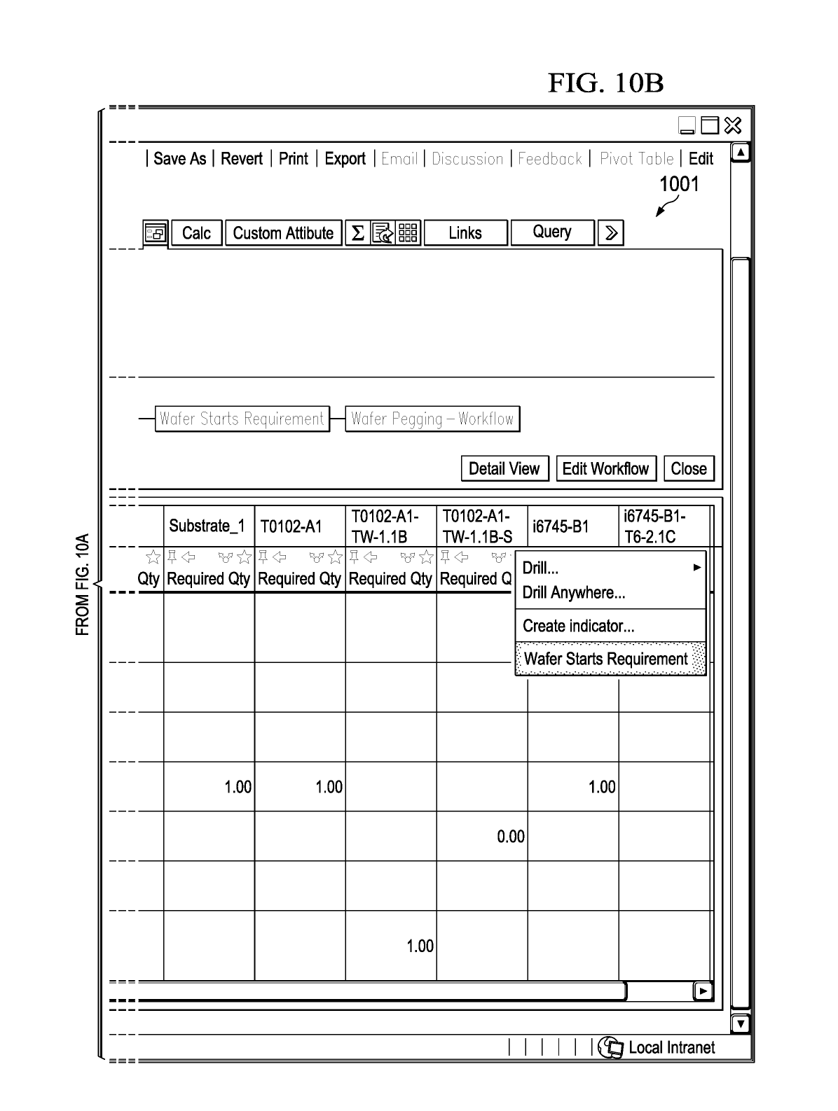

FIG. 10 (depicted as FIGS. 10A and 10B) illustrates a guided analysis path incorporating a fishbone path 1002. A fishbone path 1002, as displayed on the user workspace 1001, is similar to the fishbone chart 901 described above, but the fishbone path 1002 comprises several additional features. First, a fishbone path links a real demand problem, for example, a late order, via its bill of material to its real root cause, for example, factory work-order delays. Second, a fishbone path 1002 as displayed on the user workspace 1001 comprises an interactive interface to permit a supply chain planner to view data of one or more supply chain entities 120 in real time. As a planner uses the fishbone path 1002 to navigate through a root-cause analysis, as explained in connection with fishbone chart 901, data, workflows, work orders, and relevant documents may be presented to the planner in a window of the interface, so that the planner can make decisions based on real information and not simply assumptions.

In some embodiments, fishbone path 1002 comprises a root-cause analysis map that guides a supply chain plan to the root cause of a disruption and/or analyzes and diagnoses exceptions from execution of the supply chain plan. As an example only and not by way of limitation, if a supplier is late, an additional supplier is enlisted to ensure final delivery is not impacted. In order to act on this, self-learning system 110 performs a triage on the root cause. That is, if it is determined that a late shipment could cause a problem, then self-learning system 110 relates the late shipment to the magnitude of the problem it would likely cause and resolves the most harmful late shipments, not every late shipment.

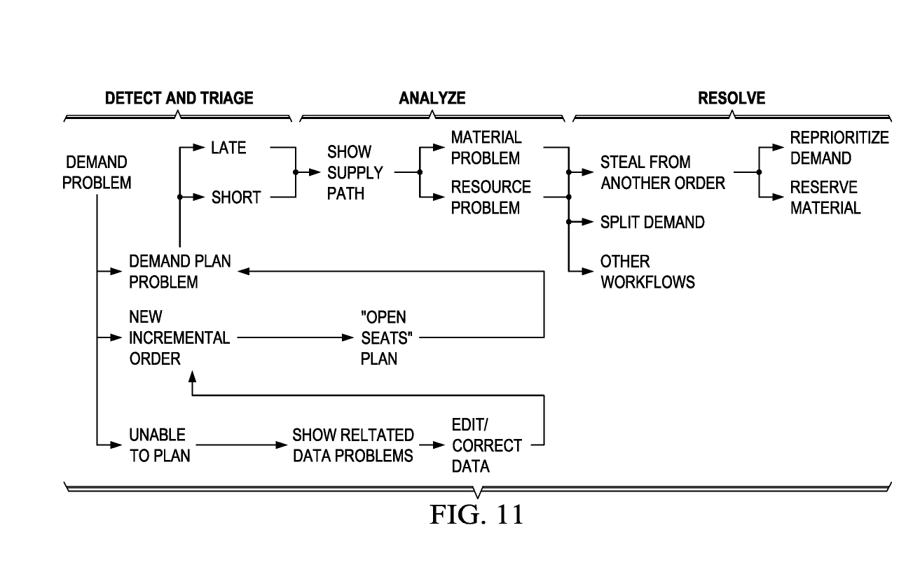

FIG. 11 is a diagram illustrating a plan for action management comprising detecting, triaging, analyzing, resolving and following up on problems during execution. In some embodiments, sensors are planted to monitor execution against a supply chain plan of one or more supply chain entities 120 to detect out of tolerance situations. In some embodiments, self-learning system 110 automatically triages detected problems based on the calculated impact to overall performance metrics. In other embodiments, self-learning system 110 determines individual problems to investigate. In some embodiments, planners use guided analytic paths to analyze root causes of a problem. In some embodiments, planners use corrective action levers and process playbooks to take and record corrective actions. In some embodiments, once a planner takes a set of corrective actions, follow up sensors are planted to monitor the results of the corrective action and confirm if desired outcomes are achieved. In some embodiments, the follow up sensors update task list alerts, action, and delegated direction and history log notes and action history.

In some embodiments, multi-dimensional segmentation is used to stratify characteristics into segments. In some embodiments, self-learning system 110 accounts for characteristics such as markets, customers, products, supply chain structures and other characteristics. In some embodiments, these segments constitute similar business preferences, similar constraint regimes and similar cost-benefit trade-offs as judged by supply chain managers.

In some embodiments, self-learning system 110 breaks the entire population into segments of like behavior; assuming the population is composed of many different segments. For example only, and not by way of limitation, a first segment might represent a first customer base, while a second segment might represents a second customer base. In some embodiments, each of these segments are given a common set of characteristics. Self-learning system 110 monitors a segment to see if it is acting as expected and groups them into a portfolio, which in turn is monitored to ensure that behavior occurs as expected. Thus, in this example, when one segment of customers significantly changes their purchasing behaviors, self-learning system 110 updates the anticipated demand projections. Alternatively if the second segment starts behaving like the first segment, then self-learning system 110 updates its anticipated demand projections to increase production and/or decrease production, as appropriate.

In some embodiments, self-learning system 110 provides a structured understanding of the portfolio and monitoring of whether members of the portfolio are acting as expected and target policies to determine if they remain valid for the member as change. In other embodiments, self-learning system 110 determines cost/benefit trade-offs based on the segment. Another embodiment of the structured learning of self-learning system 110 breaks the portfolio of customers' products into segments and micro-segments. In some embodiments, these segments and micro-segments are monitored to verify their assumed preferences remain accurate. Self-learning system 110 monitors and detects such changes and makes needed adjustments to supply chain planning.

In some embodiments, self-learning system 110 uses pattern detection, machine learning and statistical process control techniques to monitor and detect when members of a given segment fail to conform to expected and predicted behavior patterns. In some embodiments, self-learning system 110 detects deviations from anticipated behavior. To detect when something has changed, in some embodiments, self-learning system 110 selects a process, plots a control chart, takes repeated measurements at some level or interval, and analyzes the results for trends. In some embodiments, random iterations may be expected, such as, one point a little higher, one point a little lower. However, if a statistically significant number of points, such as, for example, 5 points in a row are higher than the others, then self-learning system 110 alerts a planner to a trend. In some embodiments, self-learning system 110 treats supply chain management as a process, using control charts to monitor suppliers, lead times, yields, and the like. In some embodiments, the control charts are used to detect whether something is no longer falling in a segment or whether the assumptions have been violated.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A system, comprising:
a supply chain planning database tangibly embodied on a computer-readable medium that receives supply chain data from a transaction system, and communicates the supply chain data to a planning model engine;
a risks and assumptions repository tangibly embodied on a computer-readable medium that receives supply chain data from the transaction system, and communicates updated supply chain assumptions to the supply chain planning database;
a persistent problems and work order management repository tangibly embodied on a computer-readable medium that communicates supply chain problems and supply chain problems resolutions with the planning model engine;
a root cause diagnostic library tangibly embodied on a computer-readable medium that communicates one or more performance deviations with the planning model engine; and
a planning levers library tangibly embodied on a computer-readable medium that determines at least one corrective action to resolve the one or more performance deviations.

2. The system of claim 1, wherein the system further comprises a business rules configuration manager tangibly embodied on a computer-readable medium that provides business model-specific templates and communicates with the supply chain planning database and the planning and models engine.

3. The system of claim 2, wherein the risks and assumptions repository comprises:
plan assumptions process control charts that leverage six sigma process control concepts to monitor and manage supply chain assumptions; and
early warning monitors that monitor actual execution of the supply chain and detect any known risks and root causes of the supply chain problems.

4. The system of claim 2, wherein the persistent problems and work order management repository further reconciles a cumulative work order performance by item and by facility.

5. The system of claim 2, wherein the root cause diagnostic library comprises:
a chain performance dashboard with diagnostic analytics that presents a summary of performance to plan metrics;
at least one planning-execution collaboration workflow that enables capture of how a published plan is overridden prior to accepting the published plan for execution; and
an automated plan review that that reviews published plans.

6. The system of claim 2, wherein the planning levers library comprises:
a library of levers that automates corrective actions to known or unknown risks;
a what-if analysis that evaluates feasibility and impact of levers; and
levers effectiveness monitoring and optimization.

7. A system, comprising:
a first closed loop performance monitoring system coupled with one or more supply chain networks and configured to constantly monitor at least one key assumption of the one or more supply chain networks;
a second closed loop performance monitoring system coupled with the one or more supply chain networks configured to constantly monitor at least one key process indicator of the one or more supply chain networks;
a computer system coupled with the one or more supply chain networks and configured to:
execute the plan for the one or more supply chain networks by managing the at least one key assumption to determine the validity of the assumption;
automatically utilize at least one corrective action lever when a supply chain disruption occurs;
identify one or more root causes of a plan problem that occurs during the execution of the plan;
constantly monitor one or more segments with each execution of the plan;
determine one or more contingency plans for each of the supply chain disruptions;
track the plan problem and one or more resolutions of the plan problem; and
automatically adjust the plan for one or more resolution levers by the segment with each plan execution based on the continuous monitoring of the at least one key process indicator and the at least one key assumption.

8. The system of claim 7, wherein managing the at least one key assumption comprises managing the at least one key assumption with at least one key assumption process control chart in a risks and assumptions repository.

9. The system of claim 8, wherein the computer system is further configured to:
determine one or more risks for a supply chain disruption based on monitoring execution of the plan and detecting one or more known risks and one or more root causes of supply chain disruptions;
and generate an alert when a supply chain disruption is anticipated.

10. The system of claim 9, wherein monitoring the one or more segments comprises monitoring the segments on a business rules configuration manager.

11. The system of claim 10, wherein the computer system is further configured to:
simulate results of utilizing the at least one corrective action lever prior to utilizing the at least one corrective action lever.

12. The system of claim 11, wherein the at least one corrective action lever comprises a plurality of levers and the computer system is further configured to analyze effectiveness of the at least one corrective lever and optimize association of the at least one corrective action lever with a problem alert.

13. The system of claim 12, wherein the computer system is further configured to:
determine a plurality of possible corrective action levers of the plurality of corrective action levers prioritized by relative effectiveness for the problem alert.

14. The system of claim 13, wherein the computer system is further configured to:
present plan and execution data on a supply chain performance dashboard.

15. The system of claim 14, wherein the computer system is further configured to:
present guided analysis paths on the supply chain performance dashboard.

16. The system of claim 15, wherein identifying one or more root causes of the plan problem comprises identifying how the plan is overridden before accepting a refined plan for execution.
